(19) United States
(12) Patent Application Publication
(10) Pub. No.: US 2002/0189478 A1
(43) Pub. Date: Dec. 19, 2002

(54) Offset press

(75) Inventors: Shoichi Furukawa, Hiroshima-ken (JP); Hidetoshi Ohzeki, Hiroshima-ken (JP); Yoshiyuki Yamanoue, Hiroshima-ken (JP)

Correspondence Address: ARMSTRONG,WESTERMAN & HATTORI, LLP, 1725 K STREET, NW., SUITE 1000, WASHINGTON, DC, 20006, US

(73) Assignee: Mitsubishi Heavy Industries, Ltd., Tokyo (JP)

(21) Appl. No.: 10/163,412

(22) Filed: Jun. 7, 2002

(30) Foreign Application Priority Data
Jun. 14, 2001 (JP) 2001-180714
Jun. 14, 2001 (JP) 2001-180715

(51) Int. Cl. B41N 3/00; B41M 5/00

(52) U.S. Cl. 101/465

(57) ABSTRACT

An offset press is equipped with a printer and a regenerative platemaker. The printer includes a plate cylinder on which a printing plate is fitted, and a transfer cylinder to which an image on the printing plate is transferred. The regenerative platemaker is arranged near the printer and is used to write the image to the printing plate. The printing plate is constructed of a gapless printing plat

### BACKGROUND OF THE INVENTION

(1) Field of the Invention

The present invention relates to an offset press.

(2) Description of the Related Art

FIG. 8 shows the essential part of an ordinary offset press. In the figure, reference numeral 1 denotes the printing unit of the offset press. In the case where the offset press performs multicolor printing, a plurality of printing units 1 are arranged along a traveling path for a web 2.

As shown in FIG. 8, the printing unit 1 is provided with a plate cylinder 3 and a blanket cylinder (transfer cylinder) 4. The printing unit 1 is constructed so that printing can be performed on both sides of the web 2. Therefore, the printing unit 1 is provided with upper and lower plate cylinders 3a, 3b and upper and lower blanket cylinders 4a, 4b. In the following description, when there is no need to discriminate between “upper” and “low,” the plate cylinder and the blanket cylinder are represented by reference numerals 3 and 4, respectively.

As shown in FIG. 9, each plate cylinder 3 has a printing plate 5 fitted thereon. The printing plate 5 has an image printed thereon. If ink is supplied to the plate cylinder 3 by an ink supply unit (not shown), the image on the printing plate 5 is transferred onto the blanket cylinder 4. The image transferred to the blanket cylinder 4 is printed on the web 2 being traveled.

If the image on the printing plate 5 is printed, the printing plate (old plate) 5 is removed and a new plating plate with another image printed thereon is fitted on the plate cylinder 3. After the exchange of the old and new plates, the removed printing plate 5 is discarded, because it does not have a new use.

Recently, there has been proposed a regenerative printing plate and platemaker in which an image printed on the printing plate 5 is deleted and a new image is printed again on the printing plate 5. If such a regenerative platemaker is employed, the single printing plate 5 can be repeatedly used many times and therefore costs can be reduced. In addition, the offset press is gentle on the environment.

The regenerative platemaker may be arranged separately from the printing unit 1 (this platemaker is known as a side platemaker). Alternatively, it may be constructed integrally within the printing unit 1 (this platemaker is known as an in-machine platemaker). The in-machine platemaker is arranged above the traveling path for the web 2 within the printing unit 1. This platemaker is able to print a new image on the printing plate 5 without removing the printing plate 5 from the plate cylinder 3, that is, with the printing plate 5 fitted on the plate cylinder 3. Therefore, in the case of the regenerative in-machine platemaker, the frequency of printing plate exchanges is considerably decreased.

The side platemaker is constructed separately from the printing unit 1. This side platemaker may be provided for a plurality of printing units, or for each printing unit. In such a side platemaker, if the printing plate 5 is removed from the plate cylinder 3 after printing, the printing plate 5 is fitted on the platemaker and writing of a new image is executed. After the write operation, the printing plate waits for the next plate exchange.

Therefore, the side platemaker has the following advantages over the in-machine platemaker.

(1) The in-machine platemaker must be provided so that it corresponds to a single printing unit 1 for each color. On the other hand, the side platemaker can be provided for a plurality of printing units 1. Thus, in the side platemaker, costs and installation space can be reduced and the number of troublesome maintenance operations can be reduced.

(2) The environmental conditions within the printing unit 1 are bad during operation, so it is undesirable to provide a precise machine such as a regenerative platemaker within the printing unit 1. For example, if an ink mist, splashes of a cleaning solution, paper dust, etc., adhere to the cover of a laser receiving portion provided within a regenerative platemaker, an image corresponding to this portion cannot be printed and therefore an image of poor quality will be formed.

An ordinary CTP (platemaker) corresponding to the imaging unit of an in-machine platemaker is used in a room where temperature and humidity are being controlled. Therefore, if such a platemaker is installed within the printing unit 1, there is a possibility that laser power will fluctuate due to a variation in temperature and dew will be formed due to a change in humidity.

(3) In the case where a platemaker is installed within the printing unit 1, the platemaker requires installation space and interferes with operation of the plate cylinder and the blanket cylinder, maintenance, etc.

Thus, the side platemaker which is arranged separately from the printing unit 1 has greater merit than the in-machine platemaker that is constructed integrally within the printing unit 1.

Now, a brief description will be given of an exchanging operation for the printing plate 5 in the side platemaker. When exchanging the printing plate 5, a clamp (not shown) disposed within a gap 6 in the plate cylinder 3 is first loosened to remove one end 5b of the printing plate 5 from one end of the gap 6. Then, the plate cylinder 3 is rotated in the clockwise direction shown in FIG. 9 to remove the printing plate 5. Finally, the other end 5a of the printing plate 5 is disengaged from the other end of the gap 6. In this manner, the printing plate 5 is removed from the plate cylinder 3. The operation of fitting the printing plate 5 on the plate cylinder 3 is performed in reversed order.

In the conventional offset press mentioned above, however, the printing plate exchanging operation is time-consuming and therefore costs are increased. In the case of the regenerative side platemaker, cost reduction can be achieved by repeatedly using the printing plate. However, because of increased costs resulting from the plate exchange mentioned above, the cost reduction effect of the regenerative side platemaker cannot be gained sufficiently.

### SUMMARY OF THE INVENTION

The present invention has been made in view of the circumstances mentioned above. Accordingly, it is the primary object of the present invention to provide an offset press that is capable of further reducing costs.

To achieve this end, there is provided an offset press having both a printer and a regenerative platemaker. The printer is equipped with a plate cylinder on which a printing plate is fitted, and a transfer cylinder to which an image on the printing plate is transferred. The regenerative platemaker is arranged near the printer and is used to write the image to the printing plate. The printing plate is constructed of a gapless printing plate.

With such a constitution, the offset press is capable of obtaining the synergetic effect between the advantage that the plate exchanging operation is easy and efficient and the advantage that the printing plate can be repeatedly used by the regenerative platemaker. Thus, the offset press of the present invention can achieve a substantial reduction in cost.

In the offset press of the present invention, the aforementioned regenerative platemaker is disposed beside the printer so that the printing plate can be removed from and fitted on the plate cylinder and fitted on and removed from the regenerative platemaker by being moved along the axial direction of the plate cylinder.

In this case, the removal of the printing plate (old plate) from the plate cylinder and the fitting of the printing plate (old plate) onto the regenerative platemaker can be completed in a single operation. Similarly, the removal of the printing plate (new plate) from the regenerative platemaker and the fitting of the printing plate (new plate) onto the plate cylinder can be completed in a single operation. Thus, there is an advantage that the plate exchanging operation can be more efficiently performed.

Note that in the case where a plurality of printing units are provided, a single (common) regenerative side platemaker may be provided for these printing units. In this case, a reduction in cost and a saving in space can be achieved.

In the offset press of the present invention, the plate cylinder and the transfer cylinder are constructed so that they are respectively provided with drive sources and movable in a radial direction.

With this construction, the circumferential length of the printing plate (cut off) can be varied. As a result, there is an advantage that the single offset press of the present invention can employ webs of different standards. Compared with the case where two offset presses are required, costs can be considerably reduced. In addition, a lot of space can be saved because only a place for installation of a single offset press is required.

In the offset press of the present invention, the aforementioned regenerative platemaker is constructed so that during operation of the printer, it writes a new image to the printing plate that is employed in the next printing.

In this case, the removal of an old printing plate and the fitting of a new printing plate can be continuously carried out. Thus, the time required for an exchange of plates can be appreciably shortened.

It is preferable that the aforementioned transfer cylinder be a gapless transfer cylinder. In this case, a blank between prints can be eliminated, so there is an advantage that loss of paper can be eliminated.

In the offset press of the present invention, the aforementioned gapless printing plate comprises a radially deformable gapless sleeve; a lipophobic coating, formed on the sleeve, which forms non-printing portions of the image; and a lipophilic coating, formed on the lipophobic coating, which forms printing portions of the image.

In this case, the printing plate can be fixed to the plate cylinder by friction force. Therefore, means for fixing the printing plate to the plate cylinder becomes unnecessary. Since the lipophobic coating and hydrophilic coating are formed on the sleeve, there is an advantage that regeneration and writing can be performed easily on the printing plate.

Other subjects and further features of the present invention will be apparent from the following detailed description when read in conjunction with the accompanying drawings.

### BRIEF DESCRIPTION OF THE DRAWINGS

The present invention will be described in further detail with reference to the accompanying drawings wherein:

FIG. 1 is a schematic diagram showing the essential part of an offset press according to a preferred embodiment of the present invention;

FIG. 2A is a side view of one of the printing units employed in the offset press;

FIG. 2B is a diagram showing different printing plates employed in the offset press;

FIG. 3 is a perspective view showing the gapless printing plate employed in the offset press;

FIG. 4 is an enlarged sectional view of the essential part of the gapless printing plate;

FIG. 5 is a perspective view used to explain how the gapless printing plate is removed from or fitted on the plate cylinder of the press offset;

FIG. 6 is a longitudinal sectional view of the plate cylinder employed in the offset press;

FIG. 7 is a cross sectional view of the plate cylinder employed in the offset press;

FIG. 8 is a schematic side view showing the essential part of an ordinary offset press; and

FIG. 9 is an end view of the plate cylinder and the printing plate employed in the ordinary offset press.

### DESCRIPTION OF THE PREFERRED EMBODIMENTS

An offset press according to a preferred embodiment of the present invention will hereinafter be described in detail with reference to the drawings.

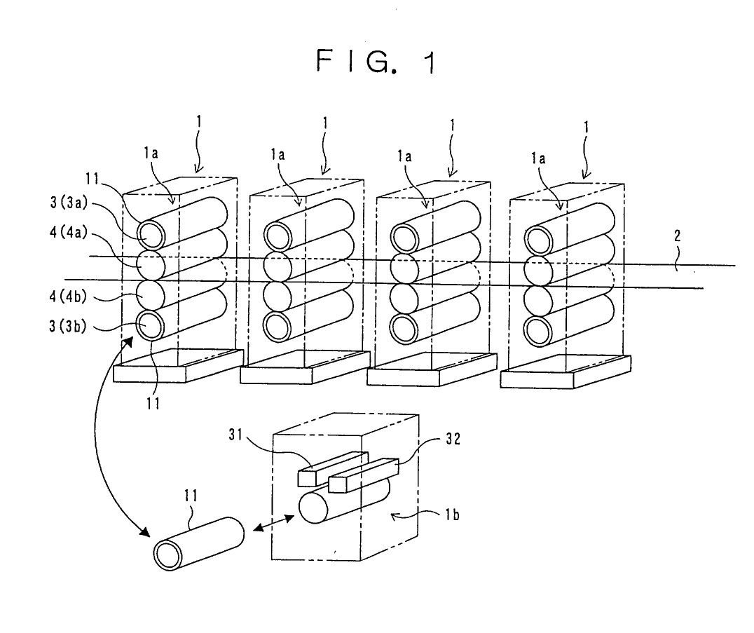

In FIG. 1, reference numeral 1 denotes a printing unit in the offset press and reference numeral 2 denotes a web. In this embodiment, each printing unit 1 is provided with a printer 1a and a regenerative side platemaker (referred to simply as a platemaker) 1b. The printer 1a is provided with upper and, lower plate cylinders 3a, 3b and upper and lower blanket cylinders (transfer cylinders) 4a, 4b. Note that the platemaker 1b may be provided for each printing unit 1, or a single platemaker may be provided for all printing units 1. In the case where there is no need to discriminate between “upper” and “low,” the plate cylinder and the blanket cylinder are represented by reference numerals 3 and 4, respectively.

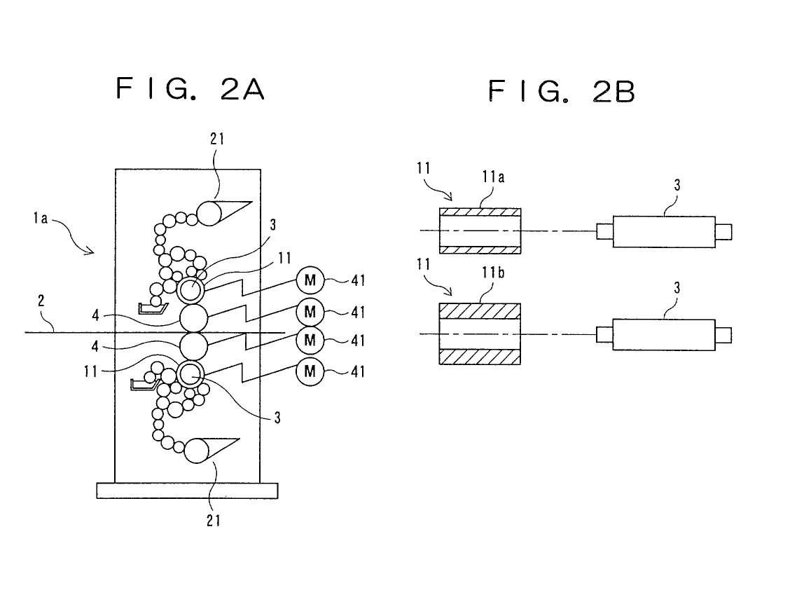

Each plate cylinder 3 is equipped with a printing plate 11, which has an image that is to be printed. Ink is supplied to the plate cylinder 3 by an ink supply unit 21 shown in FIG. 2A. If ink is supplied to the plate cylinder 3, the image on the printing plate 11 is transferred onto the blanket cylinder 4. The image transferred on the blanket cylinder 4 is printed on a web 2 being traveled.

The platemaker 1b is a device for deleting the image on the printing plate 11 after printing and then writing a new image to the printing plate 11. This platemaker 1b is provided on the side (machine side) of the printer 1a. As shown in FIG. 1, the platemaker 1b is equipped with a plate regenerator 31 for regenerating an image and a plate writer 32 for writing an image.

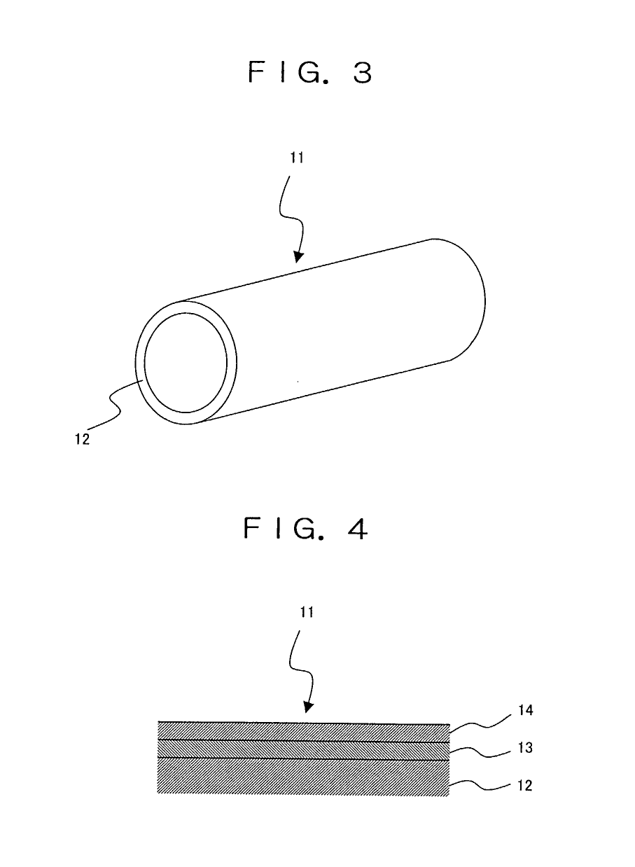

As shown in FIG. 3, the printing plate 11 is constructed as a gapless printing plate. This gapless printing plate 11 is constructed of a gapless sleeve 12. The gapless sleeve 12 has a coating (lipophobic coating) and an organic compound coating (lipophilic coating) formed thereon, as described later.

The blanket cylinder 4 has a gapless rubber plate (not shown) fitted thereon and is constructed as a gapless blanket cylinder. Because the gapless blanket cylinder is well known in the prior art, a description thereof will not be given.

The sleeve 12 is formed from an elastically deformable material such as nickel and is formed into the shape of a cylinder open at both ends. The inside diameter of the sleeve 12 is slightly smaller than the outside diameter of the plate cylinder 3 on which the sleeve 12 is fitted. Therefore, when the sleeve 12 is fitted on the plate cylinder 3, the printing plate 11 is fixed to the plate cylinder 3 by the friction force between the sleeve 12 and the plate cylinder 3.

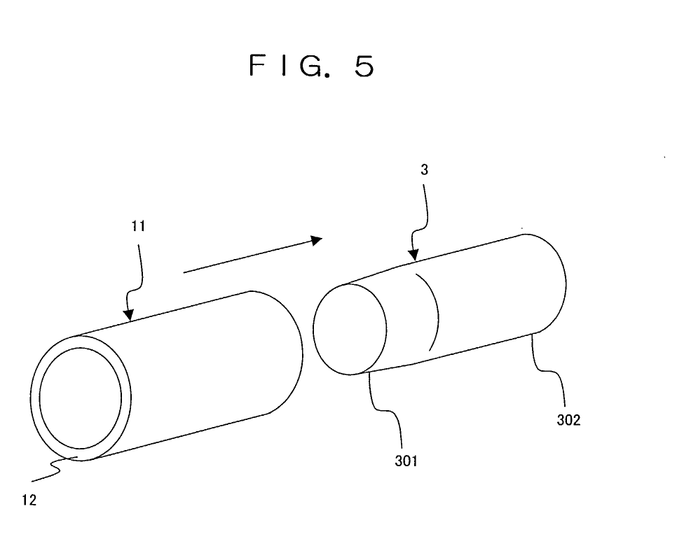

As shown in FIG. 4, the sleeve 12 has a coating (lipophobic coating) 13 of titanium dioxide (TiO₂) formed thereon. The titanium dioxide coating 13 is formed by depositing a titanium dioxide photocatalyst on the nickel sleeve 12. The titanium dioxide coating 13 functions as non-printing portions to which no ink adheres, when irradiated with active titanium dioxide photocatalyst light.

The titanium dioxide coating 13 can be formed by a chemical vapor deposition (CVD) method, a sputtering method, a sol-gel method, etc. However, the forming method is not limited to these methods. It is also possible to add the second material to the titanium dioxide coating 13 to enhance the strength of the coating 13, to enhance the adhesion between the coating 13 and the sleeve 12, to enhance the activity of the photocatalyst, or to enhance the hydrophilic property and water retentivity of the coating 13. Furthermore, an intervening layer may be provided between the nickel sleeve 12 and the titanium dioxide coating 13 to enhance the adhesion therebetween.

If the titanium dioxide coating 13 is irradiated with the aforementioned active light (i.e., ultraviolet light with a wavelength of 400 nm or less), the titanium dioxide coating 13 will exhibit high lipophobic property (hydrophilic property) by action of the titanium dioxide photocatalyst. In this manner, the exposed portions are formed as non-printing portions to which ink does not adhere. In addition, if the titanium dioxide coating 13 is irradiated with the active light, an organic compound on the photocatalyst surface can be resolved.

An organic compound coating (hydrophilic coating) 14 is formed on the titanium dioxide coating 13. The surface of the organic compound coating 14 exhibits a high hydrophilic property of repelling water but absorbing ink. The organic compound surface also has the property of being resolved by action of the titanium dioxide photocatalyst when irradiated with the aforementioned active light.

Now, a method of forming the organic compound coating 14 will be described. An organic compound, which exhibits hydrophilic property when deposited on the surface of the titanium dioxide coating 13, is dissolved or dispersed into a water or organic liquid. Then, the resultant liquid is deposited on the surface of the titanium dioxide coating 13. In this manner the organic compound coating 14 is formed. Note that after deposition, the organic compound coating 14 may be dried as needed.

An image to be printed is written to the organic compound coating 14 by the plate writer 32. The plate writer 32 is equipped with a write head for irradiating infrared laser light. If infrared laser light is irradiated to the organic compound coating 14, the exposed portions are heated and hardened, and stick fast to the titanium dioxide coating 13.

Thereafter, the unexposed portions are cleaned and removed to develop the hydrophilic non-printing portions on the titanium dioxide coating 13. In this way, an image consisting of printing portions and non-printing portions is formed on the printing plate 11.

The portions not exposed to laser light may be removed by cleaning with a cleaning agent before the start of printing, or by ink tacks after the start of printing.

The plate writer 32 is also able to employ, for example, a write head capable of irradiating the aforementioned active light. If the organic compound coating 14 is exposed to the active light, the exposed portions are dissolved and removed and the hydrophilic non-printing portions in the titanium dioxide coating 13 are developed. In this manner, an image consisting of printing portions and non-printing portions is formed on the printing plate 11.

After printing, the ink on the surface of the printing plate 11 is removed with a washer (not shown). Next, the printing plate 11 is irradiated with ultraviolet rays by an ultraviolet ray irradiating device (not shown) to dissolve and remove the printing portions consisting of an organic compound. At the same time, the surface of the titanium dioxide coating 13 is caused to be hydrophilic. Next, by coating the surface of the titanium dioxide coating 13 with an organic compound again, regeneration of the printing plate 11 becomes possible. Note that the washer and the ultraviolet ray irradiating device constitute the plate regenerator 31.

While it has been described that the coating 13 is formed by employing titanium dioxide, the coating 13 may be formed by employing aluminum instead of titanium dioxide. In this case, the lipophilic coating 14 can be formed by depositing a photosensitive resin on the aluminum coating 13.

In the platemaker 1b, a new image to be used in the next printing is written to the printing plate 11 during operation of the printer 1a. If the writing of the new image is completed, the printing plate 11 is moved to a predetermined position and waits for the next plate exchanging operation.

When an exchange of plates is performed, the printing plate (old plate) 11 is removed from the plate cylinder 3 and taken in the platemaker 1b. At nearly the same time, a new printing plate 11 is fitted on the plate cylinder 3. In this way, the time to exchange plates can be shortened.

When an exchange of plates is performed, as shown in FIG. 5, the printing plate 11 is removed from or fitted on the plate cylinder 3 by being moved away from or toward the plate cylinder 3 in the axial direction of the plate cylinder 3. This is one of the major characteristics of the cylindrical printing plate (gapless printing plate) 11. This characteristic greatly enhances the operation efficiency of the plate exchange.

The outside diameter of the plate cylinder 3 is slightly greater than the inside diameter of the sleeve 12. Therefore, by utilizing the elastic deformation of the sleeve 12, the printing plate 11 can be fixed to the plate cylinder 3. In addition, as shown in FIG. 5, the plate cylinder 3 is formed into a tape shape in which one end 301 is smaller in diameter than the other end 302. This facilitates the fitting of the printing plate 11 onto the plate cylinder 3.

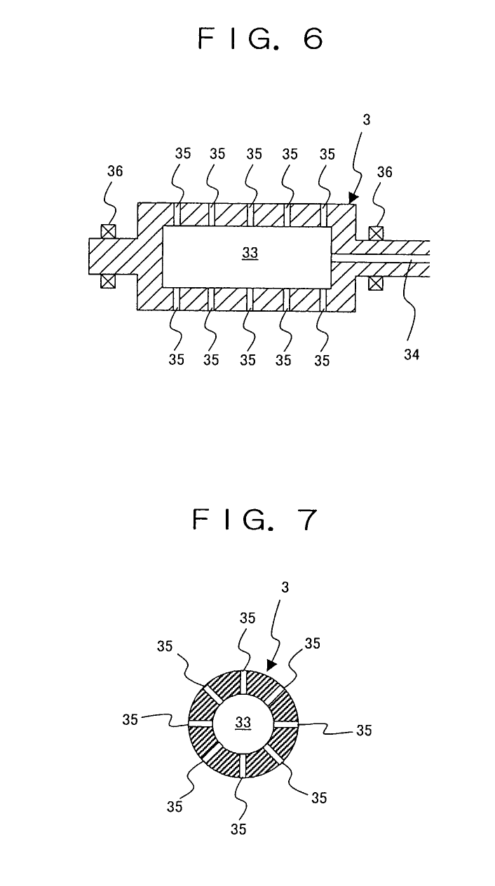

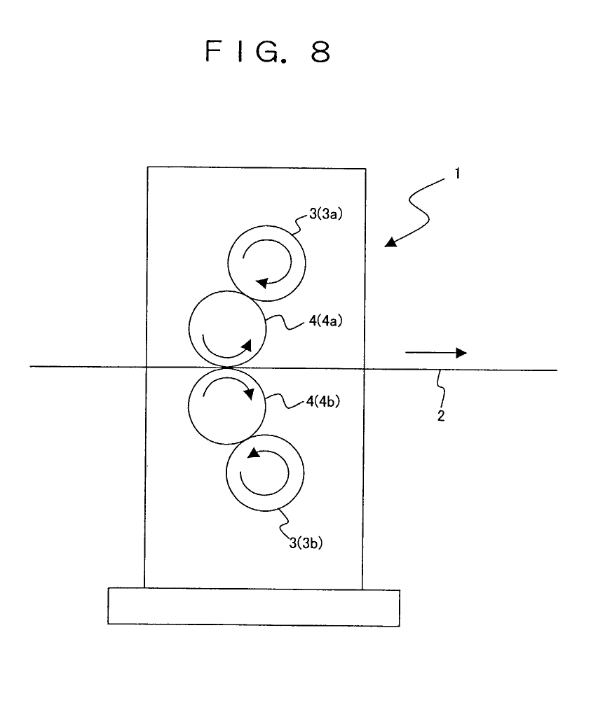

As shown in FIG. 6, the plate cylinder 3 has a cavity 33 interiorly. This cavity 33 is connected to an air pump or high-pressure fluid supply means (not shown) through an air supply passage 34, and air pressurized by this air pump is supplied to the cavity 33 through the air supply passage 34.

As shown in FIGS. 6 and 7, a plurality of air passages 35 are formed in the outer periphery of the plate cylinder 3 so that they are communicated with the cavity 33. These air passages 35 are provided over the entire length of the plate cylinder 3 at predetermined intervals in the axial direction of the plate cylinder 3, as shown in FIG. 6. The air passages 35 are also arranged in a radial manner, as shown in FIG. 7. This arrangement makes it possible to inject high-pressure air evenly at approximately the entire periphery of the plate cylinder 3. Note that the aforementioned air supply passage 34 may be connected to either one end 301 of the plate cylinder 3 or the other end 302. However, considering the operation efficiency of the plate exchange, the other end 302 of the plate cylinder 3 is preferred.

The plate cylinder 3 is rotatably supported on the frame (not shown) of the printer 1a through bearings 36. One end 301 of the plate cylinder 3 is detachably attached to the printer frame. The operation of exchanging the printing plate 11 is performed with the one end 301 of the plate cylinder 3 removed from the printer frame.

Therefore, when exchanging the printing plate 11, rotation of the plate cylinder 3 is stopped and one end 301 of the plate cylinder 3 is removed from the printer frame (not shown). Then, the air pump (not shown) is operated to supply high-pressure air to the cavity 33 of the plate cylinder 3 through the air supply passages 34. The high-pressure air acts over the entire periphery and entire length of the plate cylinder 3 through the air passages 35.

With action of the high-pressure air, the printing plate (old plate) 11 fitted on the plate cylinder 3 is elastically deformed and the inside diameter increases slightly. This increase in the inside diameter creates a slight gap between the inner peripheral surface of the printing plate 11 and the outer peripheral surface of the plate cylinder 3. In this state, the printing plate (old plate) 11 is removed by being pulled out from one end 301 of the plate cylinder 3.

When fitting the printing plate (new plate) 11 on the plate cylinder 3, the printing plate 11 is fitted on one end 301 of the plate cylinder 3 on which high-pressure air is acting. Since one end 301 of the plate cylinder 3 is slightly smaller in diameter than the other end 302, the printing plate 11 can be fitted on one end 301 of the plate cylinder 3 without being elastically deformed.

If the printing plate 11 is fitted on one end 301 of the plate cylinder 3, the printing plate 11 fitted on the plate cylinder 3 is elastically deformed by action of the high-pressure air. Therefore, by gradually pushing the printing plate 11 in the axial direction of the plate cylinder 3, it can be fitted on the plate cylinder 3. Next, the operation of the air pump is stopped, whereby the printing plate 11 returns to its original shape and is fixed to the plate cylinder 3. That is, because of the friction force between the printing plate 11 and the plate cylinder 3, the printing plate 11 is fixed to the plate cylinder 3.

After the printing plate is fitted on the plate cylinder 3 in the aforementioned manner, one end 301 of the plate cylinder 3 is attached to the printer frame again and the plate exchanging operation ends.

The platemaker 1b is arranged just beside the plate cylinder 3. As the platemaker 1b is thus arranged, the removal of the old printing plate 11 from the plate cylinder 3 and the fitting of the old printing plate 11 onto the platemaker 1b can be completed in a single operation by moving the old printing plate 11 with respect to the plate cylinder 3 in the axial direction of the plate cylinder 3. When fitting the printing plate (new plate) 11 on the plate cylinder 3, the removal of the new printing plate 11 from the platemaker 1b and the fitting of the new printing plate 11 onto the plate cylinder 3 can be similarly completed in a single operation by axially moving the new printing plate 11 held in the platemaker 1b.

The printer 1a, incidentally, is constructed as a cutoff printer capable of varying the circumferential length of the printing plate.

Now, a brief description will be given of an ordinary offset press. In the offset press, the driving force from a single drive source is usually transmitted to the printing units through shafts (driving shafts). Each plate cylinder and each blanket cylinder are connected together through gears. These gears are driven by the driving force transmitted via the aforementioned shafts. In this way, rotations of the printing units are synchronized accurately with one another.

In such a construction, however, the positions of the center axes of the plate cylinder and blanket cylinder cannot be changed because they are connected via gears. Because of this, the outside diameter of the printing plate is limited to one kind. On the other hand, webs are classified into two kinds of standards: an A-series and a B-series. For this reason, an ordinary offset press can adopt only either of the two standards for webs.

On the other hand, in the printer 1a of the preferred embodiment, the circumferential length of the printing plate is variable so that printing can be performed on both the A-series web and the B-series web. That is, as shown in FIG. 2A, the plate cylinder 3 and the blanket cylinder 4 are provided with motors 41 as drive sources, respectively. Therefore, the plate cylinder 3 and the blanket cylinder 4 can be individually driven. Although details are not shown, the plate cylinder 3 and the blanket cylinder 4 are constructed so that they are each movable in the radial direction (vertical direction shown in FIG. 2) by ball-screw mechanisms, for example.

As shown in FIG. 2B, the printing plate 11 in the preferred embodiment is provided with a first printing plate 11a whose circumferential length corresponds to the A-series and a second printing plate 11b whose circumferential length corresponds to the B-series. The first and second printing plates 11a, 11b differ in outside diameter but the same in inside diameter. Thus, they can be fitted on the same plate cylinder 3.

Such a construction enables a single offset press to meet a plurality of standards for webs. For instance, in the case where the second printing plate 11b for the B-series is used after printing is performed by the first printing plate 11a for the A-series, the plate cylinder 3 and the blanket cylinder 4 are moved to a predetermined position for the B-series before the second printing plate 11b is fitted on the plate cylinder 3.

If the second printing plate 11b is fitted on the plate cylinder 3, the plate cylinder 3 and the blanket cylinder 4 are driven by the respective motors 41 and perform printing. Note that the speed of each motor 41 is controlled on the basis of a control signal from a controller (not shown).

The offset press of the preferred embodiment has the following advantages, because it is constructed as mentioned above:

According to the offset press of the preferred embodiment, the gapless printing plate 11 is employed in combination with the platemaker 1b. Therefore, the offset press is capable of obtaining the synergetic effect between the advantage that the plate exchanging operation is easy and efficient and the advantage that the printing plate 11 can be repeatedly used by the platemaker 1b. Thus, the offset press of the present invention can achieve a substantial reduction in cost.

If the printing plate 11 is moved in the axial direction of the plate cylinder 3, the printing plate 11 can be removed from the plate cylinder 3 and fitted onto the platemaker 1b, and in addition, it can be removed from the platemaker 1b and fitted onto the plate cylinder 3. Thus, the removal of the printing plate (old plate) 11 from the plate cylinder 3 and the fitting of the printing plate (old plate) 11 onto the platemaker 1b can be completed in a single operation. Likewise, the removal of the printing plate (new plate) 11 from the platemaker 1b and the fitting of the printing plate (new plate) 11 onto the plate cylinder 3 can be completed in a single operation. Thus, there is an advantage that the plate exchanging operation can be more efficiently performed.

The plate cylinder 3 and the blanket cylinder (transfer cylinder) 4 are respectively provided with motors (drive sources) 41 and movable in the radial or vertical direction, so there is an advantage that the single offset press of the preferred embodiment can employ webs of different standards. Compared with the case where two offset presses are required, costs can be considerably reduced. In addition, a lot of space can be saved because only a place for installation of a single offset press is required.

During operation of the printer 1a, the platemaker 1b writes a new image to a printing plate that is employed in the next printing. Therefore, the removal of an old printing plate and the fitting of a new printing plate can be continuously carried out. As a result, the time required for an exchange of plates can be considerably shortened.

A combination of the gapless printing plate 11 and the gapless blanket cylinder 4 can eliminate a blank between prints, so there is an advantage that loss of paper can be eliminated. Furthermore, since the gapless printing plate 11 is formed by the elastically deformable gapless sleeve 12, the printing plate 11 can be fixed to the plate cylinder 3 by friction force, and means for fixing the printing plate 11 to the plate cylinder 3 becomes unnecessary.

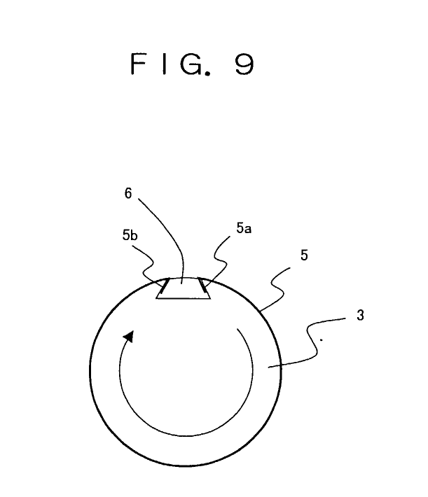

In the conventional offset press, gaps (see reference numeral 6 in FIG. 9) are present in the plate cylinder 3 and the blanket cylinder 4. Because of this, if the plate cylinder 3 and the blanket cylinder 4 make one revolution, the two gaps abut each other and therefore great load fluctuations take place in the plate cylinder 3 and the blanket cylinder 4. On the other hand, the offset press of the present invention has no gap in the plate cylinder 3 and the blanket cylinder 4 and is therefore able to eliminate such great load fluctuations.

The titanium dioxide coating (lipophobic coating) 13 forming non-printing portions is formed on the sleeve 12, and the organic compound coating (hydrophilic coating) 14 forming printing portions is formed on the titanium dioxide coating (lipophobic coating) 13. With this arrangement, there is an advantage that regeneration and writing can be performed easily on the printing plate 11.

The sleeve 12 is formed from an elastic member (e.g., nickel). Therefore, by elastically deforming the sleeve 12 when fitting the printing plate 11 on the plate cylinder 3, the printing plate 11 can be fixed to the plate cylinder 3. That is, the outside diameter of the plate cylinder 3 is made slightly greater than the inside diameter of the sleeve 12. When fitting the printing plate 11 on the plate cylinder 3, the sleeve 12 is elastically deformed so that the inside diameter thereof is increased. After the fitting of the printing plate 11, the sleeve 12 is returned to its original shape. In this manner, the printing plate 11 can be fixed to the plate cylinder 3. Because of this, there is no need to provide means for fixing the printing plate 11 to the plate cylinder 3, and a reduction in the weight of the plate cylinder 3 can be achieved. In addition, by reducing the weight of the plate cylinder 3, the force of inertia of the plate cylinder 3 can be reduced during operation of the offset press and therefore there is an advantage that accuracy of rotation is enhanced.

The plate cylinder 3 is tapered so that the diameter of one end 301 becomes smaller than that of the other end 302. This facilitates the fitting of the printing plate 11 onto the plate cylinder 3, so that there is an advantage that the operation efficiency of the plate exchange is further enhanced.

While the present invention has been described with reference to the preferred embodiment thereof, the invention is not to be limited to the details given herein, but may be modified within the scope of the invention hereinafter claimed. For example, while it has been described in the aforementioned embodiment that the side platemaker 1b is provided for each printing unit 1, only a single (common) side platemaker may be provided for a plurality of printing units 1, as in the case of color printing. For example, two side platemaker 1b may be provided for 8 printing units so that a single side platemaker 1b is employed for 4 printing units.

In addition, in this case, the side platemaker 1b may be arranged separately from the printing unit 1a and installed in a room under the control of temperature and humidity. After the printing plate needed to be exchanged is removed from the printing unit 1a, the printing plate may be fitted on the side platemaker 1b.

Furthermore, the side platemaker 1b may be provided near the printing unit 1 so that it is movable, and the side platemaker 1b may be moved sequentially to the printing plates needed to be exchanged.

In these cases, if an exchange of printing plates is executed at each printing unit 1, and the old printing plates are removed, then new patterns are written sequentially to the old printing plates by the side platemaker during the time that printing is performed using new printing plates.

In these cases, an exchange of printing plates and reproduction cannot be carried out at the same time, as is done in the aforementioned embodiment. However, a reduction in installation costs and a saving in space can be achieved, and in addition, the number of troublesome maintenance operations can be reduced.

Moreover, among all the printing plates, a predetermined number of printing plates may be made as one set, and side platemakers may be provided to the printing plates of the one set, respectively. That is, according to user needs (user needs of whether priority is given to a reduction in the time of the plate exchange and the reproducing operation, or user needs of whether priority is given to a reduction in installation costs and a saving in space), the number of installed side platemakers with respect to a printing plate can be appropriately determined.

In addition, the inside diameter of the sleeve 12 can be made slightly greater than the outside diameter of the plate cylinder 3. In this case, an exchange of plates becomes simpler and therefore the operation efficiency is considerably enhanced. In this case, means for fixing the printing plate 11 to the plate cylinder 3 becomes necessary. However, the printing plate 11 can be easily fixed to the plate cylinder 3 by generating negative pressure within the cavity 33 shown in FIGS. 6 and 7.

While it has been described that high-pressure air is supplied by the air pump (high-pressure fluid supply means), other fluids may be employed. The number and position of air passages 35 may be changed as long as they do not interfere with the plate exchanging operation.

What is claimed is:

1. An offset press comprising:
a printer comprising
a plate cylinder on which a printing plate is fitted, and
a transfer cylinder to which an image on said printing plate is transferred; and
a regenerative platemaker, arranged near said printer, for writing said image to said printing plate;
wherein said printing plate is constructed of a gapless printing plate.

2. The offset press as set forth in claim 1, wherein said regenerative platemaker is arranged beside said printer so that said printing plate can be removed from and fitted on said plate cylinder and fitted on and removed from said regenerative platemaker by being moved along an axial direction of said plate cylinder.

3. The offset press as set forth in claim 2, wherein said plate cylinder and said transfer cylinder are constructed so that they are respectively provided with drive sources and movable in a radial direction.

4. The offset press as set forth in claim 3, wherein said transfer cylinder comprises a gapless transfer cylinder.

5. The offset press as set forth in claim 4, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

6. The offset press as set forth in claim 5, wherein
said sleeve is formed from nickel, and
said lipophobic coating is formed by depositing aluminum or titanium dioxide on said sleeve.

7. The offset press as set forth in claim 6, wherein said lipophilic coating is formed by depositing an organic compound or photosensitive resin on said lipophobic coating.

8. The offset press as set forth in claim 3, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

9. The offset press as set forth in claim 8, wherein
said sleeve is formed from nickel, and
said lipophobic coating is formed by depositing aluminum or titanium dioxide on said sleeve.

10. The offset press as set forth in claim 9, wherein said lipophilic coating is formed by depositing an organic compound or photosensitive resin on said lipophobic coating.

11. The offset press as set forth in claim 2, wherein said regenerative platemaker is constructed so that during operation of said printer, it writes a new image to said printing plate that is employed in the next printing.

12. The offset press as set forth in claim 11, wherein said transfer cylinder comprises a gapless transfer cylinder.

13. The offset press as set forth in claim 12, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

14. The offset press as set forth in claim 13, wherein
said sleeve is formed from nickel, and
said lipophobic coating is formed by depositing aluminum or titanium dioxide on said sleeve.

15. The offset press as set forth in claim 14, wherein said lipophilic coating is formed by depositing an organic compound or photosensitive resin on said lipophobic coating.

16. The offset press as set forth in claim 11, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

17. The offset press as set forth in claim 16, wherein
said sleeve is formed from nickel, and
said lipophobic coating is formed by depositing aluminum or titanium dioxide on said sleeve.

18. The offset press as set forth in claim 17, wherein said lipophilic coating is formed by depositing an organic compound or photosensitive resin on said lipophobic coating.

19. The offset press as set forth in claim 2, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

20. The offset press as set forth in claim 19, wherein
said sleeve is formed from nickel, and
said lipophobic coating is formed by depositing aluminum or titanium dioxide on said sleeve.

21. The offset press as set forth in claim 20, wherein said lipophilic coating is formed by depositing an organic compound or photosensitive resin on said lipophobic coating.

22. The offset press as set forth in claim 1, wherein said printer comprises a plurality of printers, and a single regenerative side platemaker is provided for said plurality of printers.

23. The offset press as set forth in claim 22, wherein said plate cylinder and said transfer cylinder are constructed so that they are respectively provided with drive sources and movable in a radial direction.

24. The offset press as set forth in claim 23, wherein said transfer cylinder comprises a gapless transfer cylinder.

25. The offset press as set forth in claim 24, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

26. The offset press as set forth in claim 25, wherein
said sleeve is formed from nickel, and
said lipophobic coating is formed by depositing aluminum or titanium dioxide on said sleeve.

27. The offset press as set forth in claim 26, wherein said lipophilic coating is formed by depositing an organic compound or photosensitive resin on said lipophobic coating.

28. The offset press as set forth in claim 23, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

29. The offset press as set forth in claim 28, wherein
said sleeve is formed from nickel, and
said lipophobic coating is formed by depositing aluminum or titanium dioxide on said sleeve.

30. The offset press as set forth in claim 29, wherein said lipophilic coating is formed by depositing an organic compound or photosensitive resin on said lipophobic coating.

31. The offset press as set forth in claim 22, wherein said transfer cylinder comprises a gapless transfer cylinder.

32. The offset press as set forth in claim 31, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

33. The offset press as set forth in claim 32, wherein
said sleeve is formed from nickel, and
said lipophobic coating is formed by depositing aluminum or titanium dioxide on said sleeve.

34. The offset press as set forth in claim 33, wherein said lipophilic coating is formed by depositing an organic compound or photosensitive resin on said lipophobic coating.

35. The offset press as set forth in claim 22, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

36. The offset press as set forth in claim 35, wherein
said sleeve is formed from nickel, and
said lipophobic coating is formed by depositing aluminum or titanium dioxide on said sleeve.

37. The offset press as set forth in claim 36, wherein said lipophilic coating is formed by depositing an organic compound or photosensitive resin on said lipophobic coating.

38. The offset press as set forth in claim 1, wherein said plate cylinder and said transfer cylinder are constructed so that they are respectively provided with drive sources and movable in a radial direction.

39. The offset press as set forth in claim 38, wherein said transfer cylinder comprises a gapless transfer cylinder.

40. The offset press as set forth in claim 39, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

41. The offset press as set forth in claim 40, wherein said sleeve is formed from nickel, and said lipophobic coating is formed by depositing aluminum or titanium dioxide on said sleeve.

42. The offset press as set forth in claim 41, wherein said lipophilic coating is formed by depositing an organic compound or photosensitive resin on said lipophobic coating.

43. The offset press as set forth in claim 38, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

44. The offset press as set forth in claim 43, wherein said sleeve is formed from nickel, and said lipophobic coating is formed by depositing aluminum or titanium dioxide on said sleeve.

45. The offset press as set forth in claim 44, wherein said lipophilic coating is formed by depositing an organic compound or photosensitive resin on said lipophobic coating.

46. The offset press as set forth in claim 1, wherein said transfer cylinder comprises a gapless transfer cylinder.

47. The offset press as set forth in claim 46, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

48. The offset press as set forth in claim 47, wherein
said sleeve is formed from nickel, and
said lipophobic coating is formed by depositing aluminum or titanium dioxide on said sleeve.

49. The offset press as set forth in claim 48, wherein said lipophilic coating is formed by depositing an organic compound or photosensitive resin on said lipophobic coating.

50. The offset press as set forth in claim 1, wherein said gapless printing plate comprises
a radially deformable gapless sleeve,
a lipophobic coating, formed on said sleeve, which forms non-printing portions of said image, and
a lipophilic coating, formed on said lipophobic coating, which forms printing portions of said image.

51. The offset press as set forth in claim 50, wherein
said sleeve is formed from nickel, and
said lipophobic coating is formed by depositing aluminum or titanium dioxide on said sleeve.

52. The offset press as set forth in claim 51, wherein said lipophilic coating is formed by depositing an organic compound or photosensitive resin on said lipophobic coating.
